(19) United States
(12) Patent Application Publication
(10) Pub. No.: US 2015/0309367 A1
(43) Pub. Date: Oct. 29, 2015

(54) DISPLAY DEVICE AND METHOD OF MANUFACTURING THE SAME

(71) Applicant: Samsung Display Co., Ltd., Yongin-City (KR)

(72) Inventors: Chan-Jae PARK, Osan-si (KR); SEOKHYUN NAM, Seoul (KR); Seung Hwan BAEK, Seoul (KR); Yeongbae LEE, Suwon-si (KR)

(21) Appl. No.: 14/599,716

(22) Filed: Jan. 19, 2015

(30) Foreign Application Priority Data
Apr. 29, 2014 (KR) 10-2014-0051718

(51) Int. Cl. G02F 1/1335

(52) U.S. Cl. CPC G02F 1/133606; G02F 1/133605; G02F 1/133609

(57) ABSTRACT

A display device includes a display panel including a display surface on which an image is displayed and a rear surface opposite to the display surface, and a backlight unit which is under the display panel and supplies a light to the display panel. The backlight unit includes a light source unit which emits a first light in a direction taken from the display surface to the rear surface, a reflection sheet which reflects the first light, and an active layer which is between the light source unit and the reflection sheet and includes a scattering particle which scatters the first light.

This application claims priority to Korean Patent Application No. 10-2014-0051718, filed on Apr. 29, 2014, and all the benefits accruing therefrom under 35 U.S.C. §119, the contents of which are hereby incorporated by reference in its entirety.

### BACKGROUND

1. Field

The invention relates to a display device and a method of manufacturing the same. More particularly, the invention relates to a display device having improved viewing angle and a method of manufacturing the display device.

2. Description of the Related Art

A non-light emission display device such as a liquid crystal display device, an electrophoretic display device, an electrowetting display device, etc., includes a backlight unit to supply light to a display panel, in order to display an image.

The backlight unit is classified into an edge-illumination type backlight unit and a direct-illumination type backlight unit according to a position of a light source with respect to a display surface of the display panel on which the image is displayed.

The direct-illumination type backlight unit omits a light guide plate and a heat discharge member, which are applied to the edge-illumination type backlight unit, and thus a manufacturing cost of the direct-illumination type backlight unit is reduced compared to that of the edge-illumination type backlight unit. In addition, a light loss of the direct-illumination type backlight unit is smaller than that of the edge-illumination type backlight unit. Therefore, the direct-illumination type backlight unit has brightness higher than that of the edge-illumination type backlight unit even though the direct-illumination type backlight unit and the edge-illumination type are applied with the same voltage.

Research of the non-light emission display device has focused on issues such as reduction in manufacturing cost and thickness thereof, and improvement in viewing angle thereof.

### SUMMARY

One or more exemplary embodiment of the invention provides a display device having improved viewing angle.

One or more exemplary embodiment of the invention provides a method of manufacturing the display device having the improved viewing angle.

An exemplary embodiment of the invention provides a display device including a display panel including a display surface on which an image is displayed and a rear surface opposite to the display surface, and a backlight unit which is under the display panel and supplies a light to the display panel. The backlight unit includes a light source unit which emits a first light in a direction taken from the display surface to the rear surface, a reflection sheet which reflects the first light, and an active layer between the light source unit and the reflection sheet and including a scattering particle which scatters the first light.

The active layer may further include a light emission particle which receives the first light and generates a second light having a wavelength different from a wavelength of the first light

The light emission particle may include a fluorescent substance or a quantum dot.

The light source unit may include a light source, and a circuit board which applies a power source voltage to the light source mounted on a surface of the circuit board. The light source may be protruded toward the reflection sheet.

The circuit board may be transparent or semi-transparent.

The light source unit may further include a light emission cover layer which covers the light source on the circuit board. The light emission cover layer may include a fluorescent substance or a quantum dot.

The backlight unit may further include a light emission particle layer between the display panel and the circuit board. The light emission particle layer may include a fluorescent substance or a quantum dot.

The backlight unit may further include a reflection pattern between the display panel and the light source unit. The reflection pattern may overlap the light source in a plan view.

The backlight unit may further include an optical member between the display panel and the light source unit. The optical member may include a concavo-convex shape at a surface thereof.

The backlight unit may further include a reflector which is between the reflection sheet and the light source unit and reflects the first light.

The reflector may overlap the light source.

The reflector may have a cone shape, a truncated cone shape, an n pyramid shape or an m truncated pyramid shape, where each of “n” and “m” is a natural number equal to or greater than 3.

The scattering particle may include at least one metal selected from gold, silver, aluminum, platinum, palladium, cadmium, cobalt, ruthenium, copper, indium, nickel and iron, an alloy thereof, titanium dioxide (TiO₂) and silicon dioxide (SiO₂).

An exemplary embodiment of the invention provides a method of manufacturing a display device, including mounting a light source on a surface of a circuit board to form a light source unit, forming a damper on a reflection sheet to define a space on the reflection sheet, forming an active layer including a scattering particle in the space on the reflection sheet, and attaching the light source unit to the damper to seal the active layer.

The active layer may further include a light emission particle.

The method may further include forming a light emission cover layer which covers the light source on the circuit board.

The method may further include forming a light emission particle layer between the display panel and the circuit board.

The method may further include forming a reflection pattern on a surface of the circuit board opposite to that on which the light source is mounted. The reflection pattern may overlap the light source in a plan view.

The method may further include forming a reflector on the reflection sheet. The reflector may overlap the light source in a plan view.

According to one or more exemplary embodiment of the invention described above, the viewing angle of the light becomes widened and visibility of the display device is improved.

### BRIEF DESCRIPTION OF THE DRAWINGS

The above and other advantages of the invention will become readily apparent by reference to the following detailed description when considered in conjunction with the accompanying drawings wherein:

FIG. 1 is an exploded perspective view of an exemplary embodiment of a display device according to the invention;

FIG. 2 is a plan view of an exemplary embodiment of a display device according to the invention;

FIGS. 3A to 3D are cross-sectional views of exemplary embodiments of a backlight unit of a display device according to the invention;

FIGS. 4A to 4D are cross-sectional views of other exemplary embodiments of a backlight unit of a display device according to the invention;

FIGS. 5A to 5D are cross-sectional views of still other exemplary embodiments of a backlight unit of a display device according to the invention;

FIGS. 6A to 6H are views showing various shapes of exemplary embodiments of a reflector of a backlight unit according to the invention;

FIGS. 7A to 7D are cross-sectional views of yet other exemplary embodiments of a backlight unit according to the invention;

FIG. 8 is a flowchart showing an exemplary embodiment of a manufacturing method of a display device according to the invention; and

FIGS. 9A to 9D are views of an exemplary embodiment of a manufacturing method of a display device according to the invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, connected may indicate physical and/or electrical connection. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “under,” “above” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” other elements or features would then be oriented “above” the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be explained in detail with reference to the accompanying drawings.

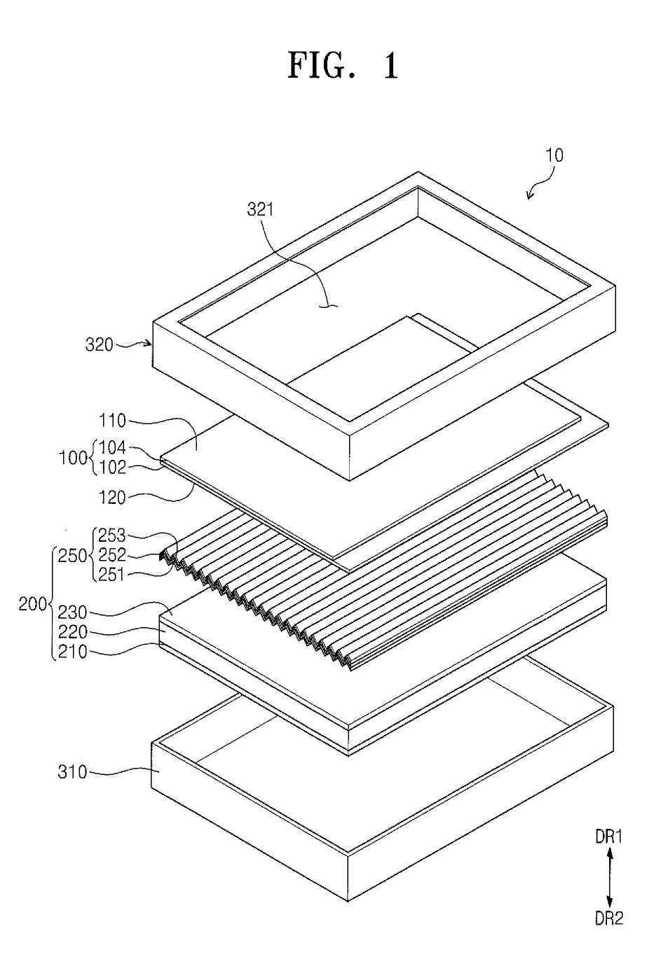

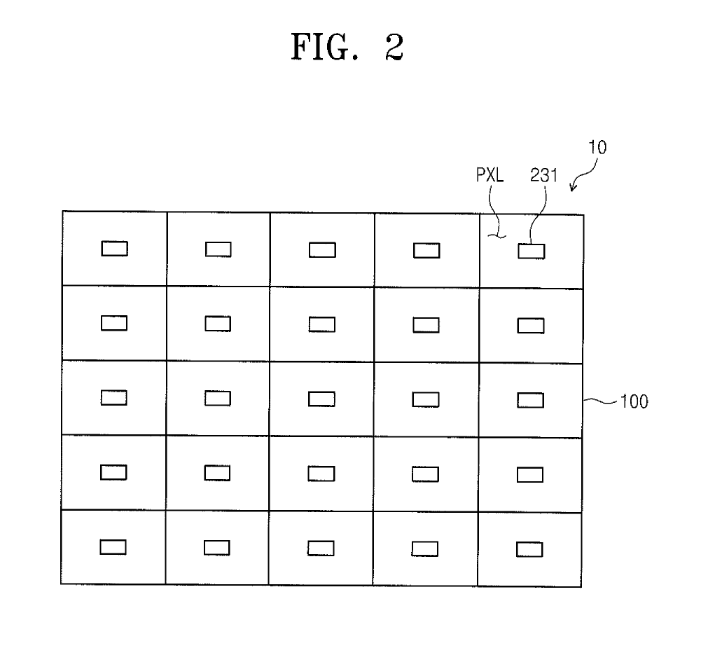

FIG. 1 is an exploded perspective view of an exemplary embodiment of a display device according to the invention and FIG. 2 is a plan view of an exemplary embodiment of a display device according to the invention.

Referring to FIGS. 1 and 2, a display device 10 includes a display panel 100, a backlight unit 200, a bottom chassis 310 and a top chassis 320.

The display panel 100 includes a display area, which includes a display surface 110 on which an image is displayed and a rear surface 120 facing opposite to the display surface 110, and a non-display area in which the image is not displayed. As the display panel 100, a non-light emission display panel with which a separate backlight unit is used rather than a light emission display panel, e.g., an organic light emitting display panel. In an exemplary embodiment, for instance, various display devices, such as a liquid crystal display panel, an electrophoretic display panel, etc., are used as the display panel 100. In the illustrated exemplary embodiment, the liquid crystal display panel will be described as the display panel 100.

The display panel 100 has a quadrangular plate shape, but is not limited thereto or thereby. The display panel 100 includes a first substrate 104, a second substrate 102 facing the first substrate 104, and a liquid crystal layer (not shown) interposed between the first and second substrates 104 and 102.

The first substrate 104 includes a plurality of gate lines (not shown) extending in a first direction, and a plurality of data lines (not shown) extending in a second direction crossing the first direction while being insulated from the gate lines (not shown). The first substrate 104 includes a plurality of pixel areas (not shown) arranged thereon in a matrix form. Each pixel area PXL (refer to FIG. 2) includes a thin film transistor (not shown) and a pixel electrode (not shown). The thin film transistor includes a gate electrode (not shown) electrically connected to a corresponding gate line of the gate lines, a source electrode (not shown) electrically connected to a corresponding data line of the data lines, and a drain electrode (not shown) electrically connected to the pixel electrode. Accordingly, the thin film transistor switches signals used to control or drive the pixel electrode.

The second substrate 102 includes a color filter (not shown) that assigns a color to a light passing therethrough and a common electrode (not shown) disposed on the color filter to face the pixel electrode. According to an exemplary embodiment, the color filter and the common electrode may be disposed on the first substrate 104 instead of the second substrate 102.

The liquid crystal layer (not shown) is disposed between the first and second substrates 104 and 102. The liquid crystal layer includes liquid crystal molecules aligned in a specific direction in response to an electric field formed between the first and second substrates 104 and 102 by voltages respectively applied to the pixel electrode and the common electrode. Therefore, a transmittance of the light generated by the backlight unit 200 and passing through the liquid crystal layer is controlled, and thus the display panel 100 displays a desired image.

The display device 10 includes the backlight unit 200. The backlight unit 200 is disposed under the display panel 100 and supplies the light to the display panel 100.

The backlight unit 200 includes a reflection sheet 210, an active layer 220 and a light source unit 230. The light source unit 230 emits a first light in a downward direction, e.g., a direction from the display surface 110 to the rear surface 120 of the display panel 100. The light source unit 230 includes a light source 231 and a circuit board.

The light source 231 is disposed corresponding to one or more pixel area PXL, and the number of light sources 231 disposed in a single pixel area PXL is not limited to a specific number condition. That is, one pixel area PXL may include two or three light sources 231 or one common light source 231 may be arranged to correspond to two or three pixel areas PXL.

The reflection sheet 210, the active layer 220 and the light source unit 230 will be described in detail later.

The backlight unit 200 may further include an optical member 250 disposed between the display panel 100 and the light source unit 230. The optical member 250 may improve brightness and viewing angle of the light exiting from an exiting surface thereof.

The optical member 250 includes a first optical sheet 251, a second optical sheet 252 and a third optical sheet 253, which are sequentially stacked one on another. The stacking order of the first, second and third optical sheets 251, 252 and 253 is not limited thereto or thereby.

The first optical sheet 251 may be a diffusion sheet configured to diffuse the light emitted from the light source unit 230. The second optical sheet 252 may be a prism sheet configured to condense the light diffused by the diffusion sheet 251 and allow the light to travel in a direction substantially vertical to a plane of the display panel 100 disposed thereon. The third optical sheet 253 may be a protection sheet configured to protect the prism sheet from external impacts thereto. In the illustrated exemplary embodiment, one of the first, second and third optical sheets 251 to 253 may be provided in plural number, or one or more of the first to third optical sheets 251 to 253 may be omitted from the optical member 250.

A surface of the optical member 250 has a concavo-convex shape. The concavo-convex shape of the optical member 250 is formed by a partially protruded surface of the optical member 250 toward a direction DR1, e.g., a direction from the rear surface 120 to the display surface 110 of the display panel 100.

The optical member 250 having the concavo-convex shape may diffuse the light in various directions, and thus the viewing angle of the light may be improved.

The bottom chassis 310 includes a receiving space defined therein to accommodate the reflection sheet 210, the active layer 220 and the light source unit 230.

The bottom chassis 310 includes a bottom portion, and a sidewall extending upward from the bottom portion. In FIG. 1, inner and outer surfaces of the sidewall extend in a direction substantially vertical to the bottom portion, but is not limited thereto or thereby. That is, the inner surface of the sidewall may be inclined with respect to the bottom portion.

The top chassis 320 faces and is coupled with the bottom chassis 310. The top chassis 320 covers an edge of the display panel 100, and an opening 321 is defined in the top chassis 320 to expose the display area of the display panel 100.

The display device 10 further includes a mold frame (not shown) disposed between the bottom chassis 310 and the top chassis 320 and configured to support the display panel 100. The mold frame (not shown) reduces or effectively prevents the backlight unit 200 from being separated from the bottom chassis 310 and supports the display panel 100. The top chassis 320 is coupled with the bottom chassis 310 to reduce or effectively prevent separation of the display panel 100 from the mold frame (not shown).

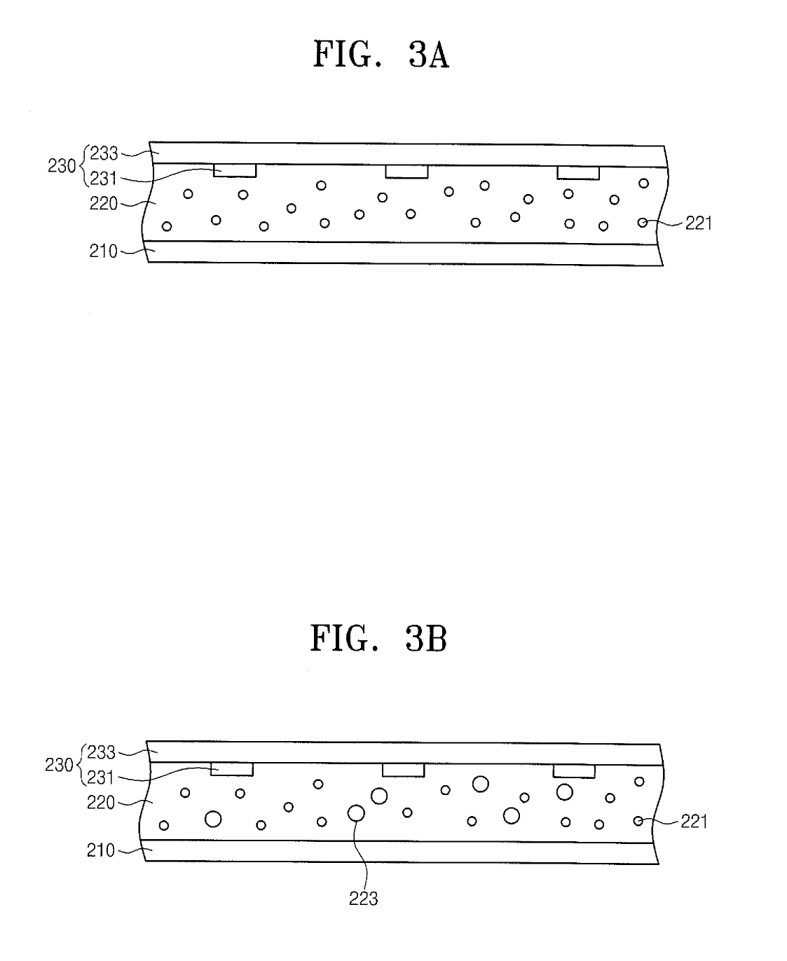

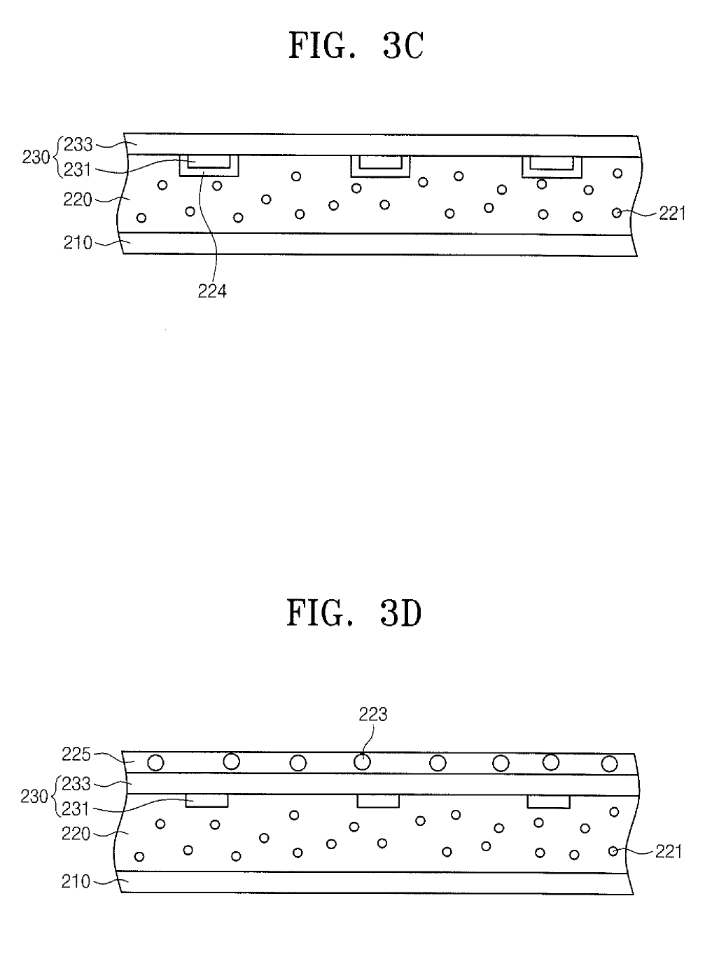

FIGS. 3A to 3D are cross-sectional views of exemplary embodiments of the backlight unit 200 according to the invention.

Referring to FIGS. 3A to 3D, the backlight unit 200 includes the reflection sheet 210, the active layer 220, and the light source unit 230.

The light source unit 230 emits the light in the direction from the display surface 110 to the rear surface 120 of the display panel 100. The light source unit 230 includes the light source 231 and a circuit board 233.

The light source 231 emits the first light in response to the driving voltage provided from an external source (not shown), and the first light may be a blue light but is not limited thereto or thereby.

The light source 231 may be a light emitting diode and may be provided in a plural number. The light source 231 emits the first light at a predetermined angle with respect to a light axis substantially vertical to the light source 231.

The light source 231 is protruded toward the reflection sheet 210, e.g., a direction DR2.

A conventional display device includes the light source disposed under the active layer, and the light source emits the first light in the direction DR1 from the rear surface to the display surface of a display panel. However, in one or more exemplary embodiment of the display device 10 according to the invention, the light source 231 is disposed on the active layer 220 and emits the light in the direction DR2 which is taken from the display surface 110 to the rear surface 120 of the display panel 100. That is, the light source 231 emits the light in a direction away or opposite to from the viewing side of the display device 10.

The circuit board 233 applies a power source voltage to the light source 231 mounted on a surface thereof.

The circuit board 233 may be transparent or semi-transparent, and thus the first light may be efficiently supplied to the display panel 100.

The reflection sheet 210 is disposed under the light source unit 230. In addition, the reflection sheet 210 is disposed inside the bottom chassis 310. Where the reflection sheet 210 is disposed inside the bottom chassis 310, the reflection sheet 210 may be laminated onto the bottom chassis 310. The reflection sheet 210 reflects most of the first light traveling thereto. In detail, the reflection sheet 210 reflects the first light emitted from the light source 231 to the upper direction DR1 at various angles.

In an exemplary embodiment, the reflection sheet 210 is a film including a white pigment in a polyester resin, or a film containing micro-bubbles therein, but is not limited thereto or thereby.

The reflection sheet 210 includes a material, e.g., polyethylene terephthalate (“PET”), aluminum, etc., configured to reflect the light.

The active layer 220 is disposed between the reflection sheet 210 and the light source unit 230. The active layer 220 includes a silicon-based resin.

The active layer 220 includes scattering particles 221 configured to scatter a portion of the first light. The scattering particles 221 includes at least one metal selected from gold, silver, aluminum, platinum, palladium, cadmium, cobalt, ruthenium, copper, indium, nickel and iron, an alloy thereof, titanium dioxide (TiO₂) and silicon dioxide (SiO₂).

Referring to FIGS. 3B to 3D, the active layer 220 includes light emission particles 223 configured to receive the first light and generate a second light having a wavelength different from that of the first light. The light emission particles 223 are disposed at various positions.

When the active layer 220 includes the light emission particles 223, the scattering particles 221 diffuse a portion of the second light. In addition, the reflection sheet 210 reflects the portion of the second light.

Referring to FIG. 3B, the active layer 220 further includes the light emission particles 223. The light emission particles 223 are configured to receive the first light and generate the second light having the different wavelength from that of the first light. In an exemplary embodiment, for instance, when the first light is the blue light, the second light is a green or red light. The light emission particles 223 may include a fluorescent substance or a quantum dot, but are not limited thereto or thereby. In FIG. 3B, the active layer 220 includes the scattering particles 221 and the light emission particles 223, but in an exemplary embodiment, the active layer 220 may include only the light emission particles 223.

Referring to FIG. 3C, the light source unit 230 further includes a light emission cover layer 224. The light emission cover layer 224 covers the light source 231 disposed on the circuit board 223. The light emission cover layer 224 is configured to receive the first light and generate the second light having the different wavelength from that of the first light. In an exemplary embodiment, for instance, when the first light is the blue light, the second light is the green or red light. The light emission cover layer 224 may include a fluorescent substance or a quantum dot, but is not limited thereto or thereby. Where the light source unit 230 further includes the light emission cover layer 224, the active layer 220 may exclude the light emission particles 223, but the invention is not limited thereto or thereby.

Referring to FIG. 3D, the backlight unit 200 further includes a light emission particle layer 225. The light emission particle layer 225 is disposed between the display panel 100 and the circuit board 223. The light emission particle layer 225 may be a discrete layer between the display panel 100 and the circuit board 223. The light emission particle layer 225 is configured to receive the first light and generate the second light having the different wavelength from that of the first light. In an exemplary embodiment, for instance, when the first light is the blue light, the second light is the green or red light.

The light emission particle layer 225 includes a silicon-based resin. The light emission particle layer 225 includes the light emission particles 223 disposed therein. The light emission particles 223 may include a fluorescent substance or a quantum dot, but are not limited thereto or thereby. Where the backlight unit 200 further includes the light emission particle layer 225, the active layer 220 may exclude the light emission particles 223, but the invention is not limited thereto or thereby.

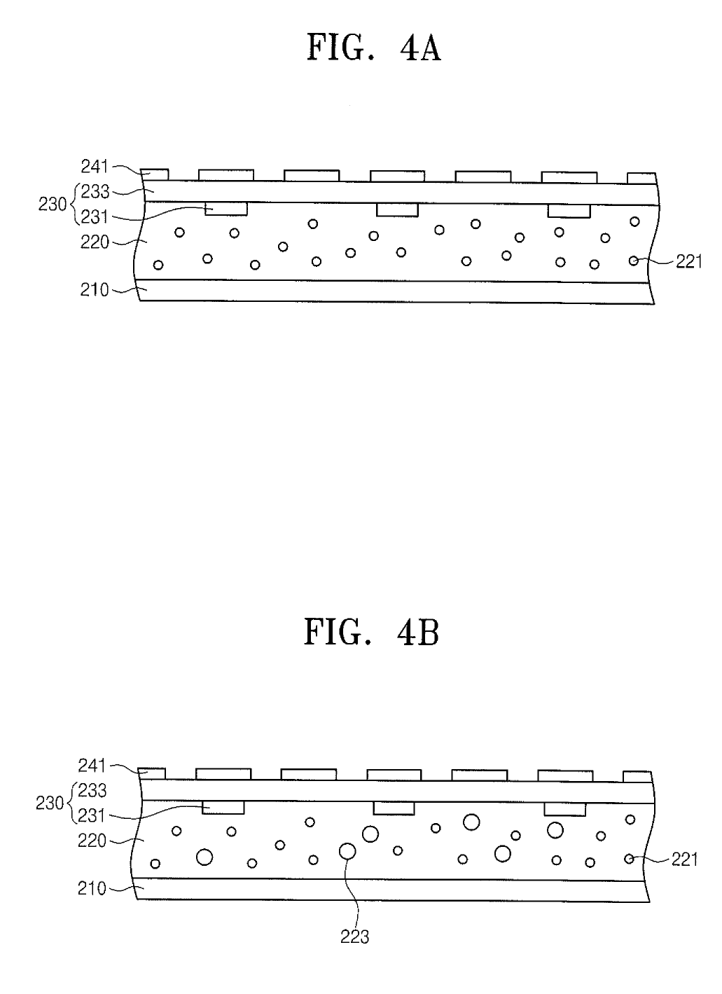

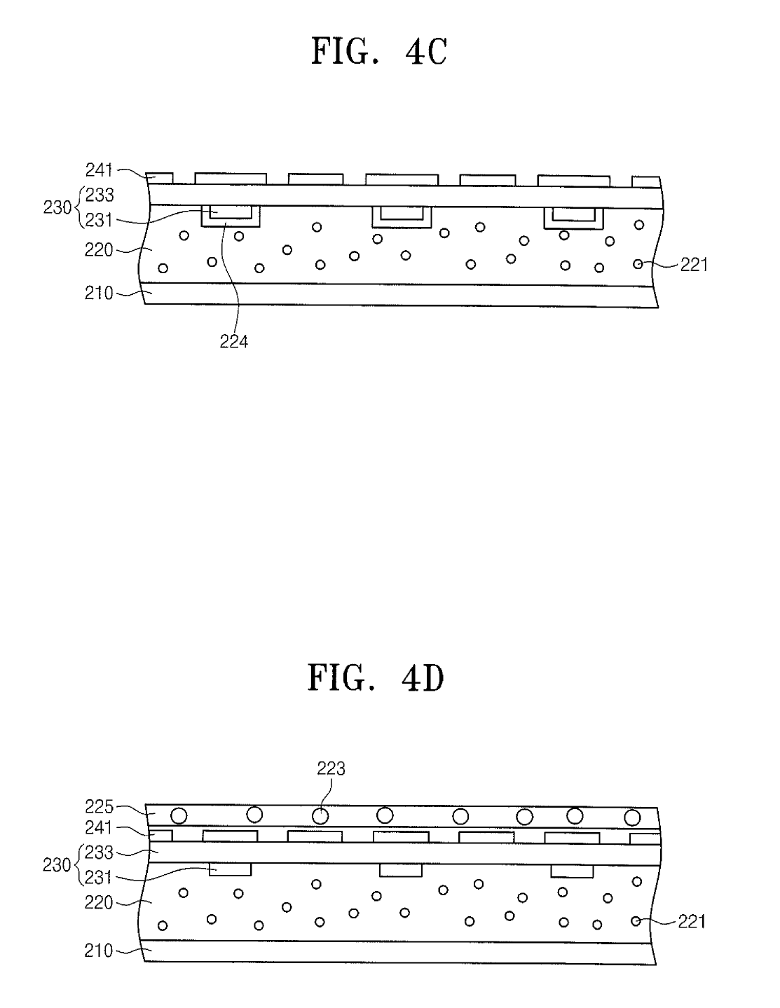

FIGS. 4A to 4D are cross-sectional views of other exemplary embodiments of a backlight unit of a display device according to the invention.

Referring to FIGS. 4A to 4D, the backlight unit 200 further includes a reflection pattern 241. The reflection pattern 241 is disposed between the display panel 100 and the light source unit 230.

A portion of the reflection pattern 241 covers (e.g., overlaps) the light source 231 and the reflection pattern 241 is provided in a plural number.

In FIGS. 4A to 4D, the reflection pattern 241 is disposed at a position not corresponding to (e.g., not overlapping) the light source 231, but is not limited thereto or thereby. That is, the reflection pattern 241 may be disposed only at a position corresponding to (e.g., overlapping) the light source 231 to cover the light source 231.

A portion of the reflection pattern 241 covers the light source 231 when viewed in a thickness direction, e.g., the direction DR1 or a top plan view, of the display panel 100. When the reflection pattern 241 covers the light source 231, a viewer recognizing the reflection pattern 241 as a foreign object when the viewer views the image displayed through the display device is reduced or effectively prevented.

In addition, the reflection pattern 241 reflects the first and second lights, and thus the efficiency of the light supplied to the display panel 100 is improved.

The reflection pattern 241 includes the same material as that of the reflection sheet 210. The reflection pattern 241 includes a white pigment in a polyester resin, or includes micro-bubbles therein, but is not limited thereto or thereby. According to an exemplary embodiment, the reflection pattern 241 may include a different material from that of the reflection sheet 210.

The reflection pattern 241 includes a material that is configured to reflect the light, e.g., PET or aluminum.

The reflection pattern 241 has various shapes, e.g., a circular shape, an oval shape, a triangular shape, a quadrangular shape, etc., when viewed in the thickness direction of the display panel 100, e.g., the collective directions DR1 and DR2 as a cross-sectional view. The cross-sectional shape of the reflection pattern 241 are not limited to a specific shape as long as the portion of the reflection pattern 241 covers the light source 231.

Referring to FIG. 4A, the reflection pattern 241 is disposed on the active layer 220 including the scattering particles 221. The reflection pattern 241 is disposed on the active layer 220 including the scattering particles 221 to cover the light source 231.

Referring to FIG. 4B, the reflection pattern 241 is disposed on the active layer 220 including the scattering particles 221 and the light emission particles 223. The reflection pattern 241 is disposed on the active layer 220 including the scattering particles 221 and the light emission particles 223 to cover the light source 231.

Referring to FIG. 4C, the reflection pattern 241 is disposed on the light source unit 230 including the light emission cover layer 224. The reflection pattern 241 is disposed on the light source unit 230 including the light emission cover layer 224 to cover the light source 231.

Referring to FIG. 4D, the reflection pattern 241 is disposed on the light emission particle layer 225. The reflection pattern 241 is disposed on the light emission particle layer 225 to cover the light source 231.

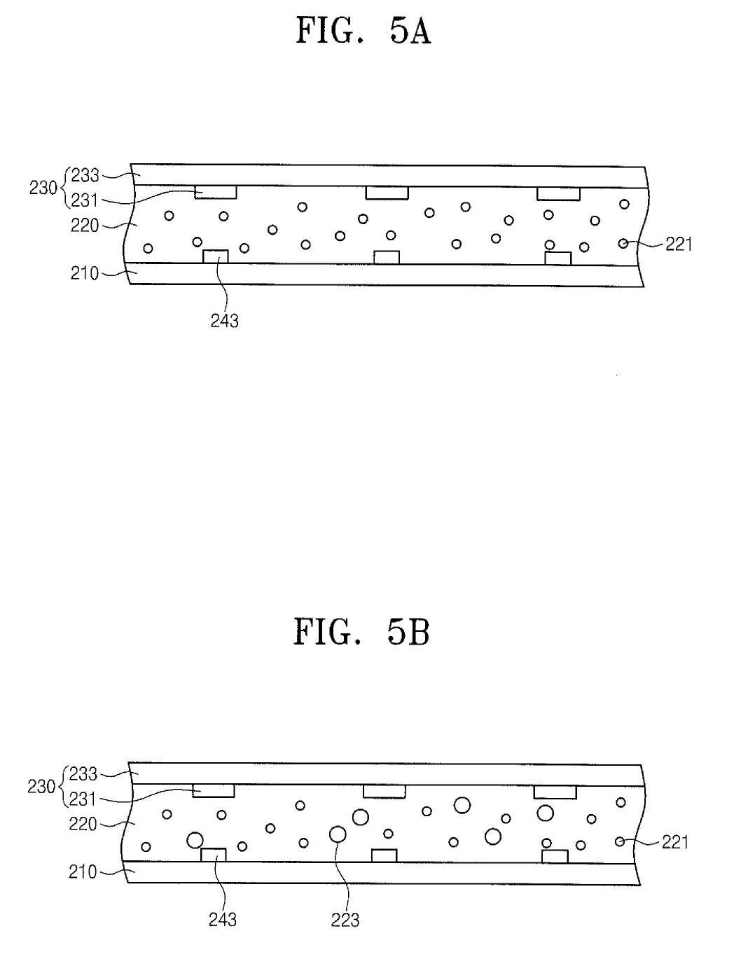

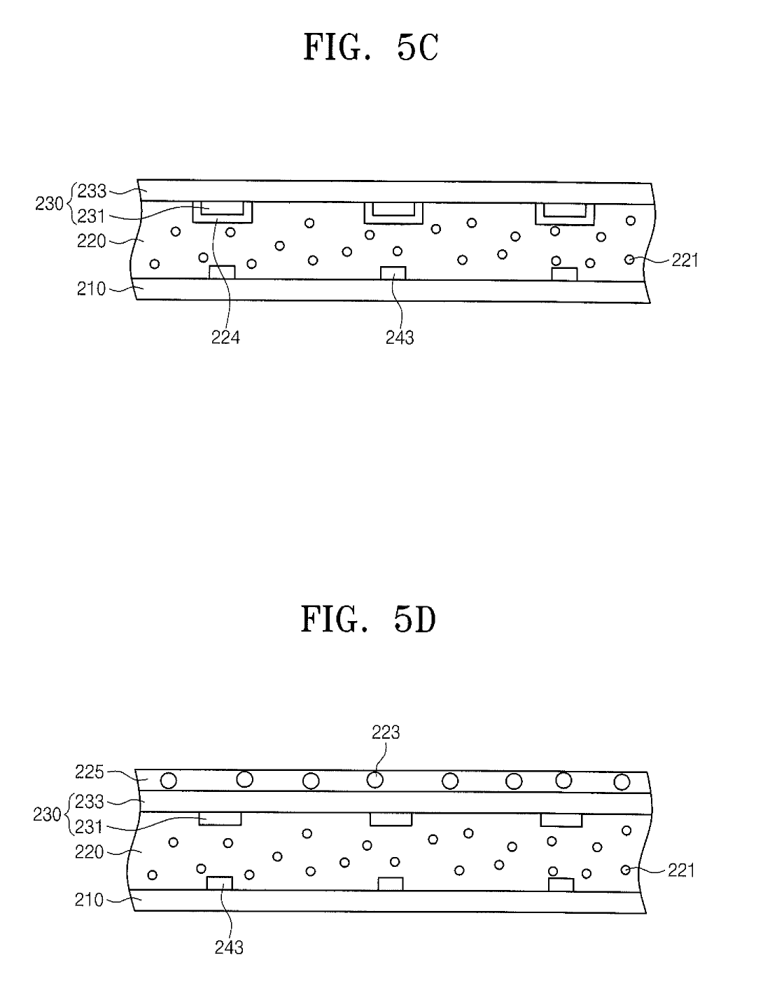

FIGS. 5A to 5D are cross-sectional views showing still other exemplary embodiments of a backlight unit of a display device according to the invention.

Referring to FIGS. 5A to 5D, the backlight unit 200 further includes a reflector 243. The reflector 243 is disposed on the reflection sheet 210 and is considered in the active layer 220.

The reflector 243 is overlapped with a portion of the light source 231. In an exemplary embodiment, for instance, when viewed in the thickness direction of the display panel 100, e.g., the direction DR1 and DR2, the reflector 243 is overlapped with a portion of the light source 231.

The reflector 243 is provided in a plural number.

The reflector 243 is disposed under the light source 231 and partially overlapped with the light source 231, and configured to reflect the first light emitted from the light source 231 to various directions. Accordingly, the viewing angle of the display device may be improved and the visibility of the viewer may be improved.

In addition, the reflector 243 is configured to reflect the second light to various directions.

The reflector 243 includes the same material as that of the reflection sheet 210. The reflector 243 includes a white pigment in a polyester resin or includes micro-bubbles therein, but is not limited thereto or thereby. In an exemplary embodiment, the reflector 243 may include a different material from that of the reflection sheet 210.

The reflector 243 includes a material that is configured to reflect the light, e.g., PET or aluminum.

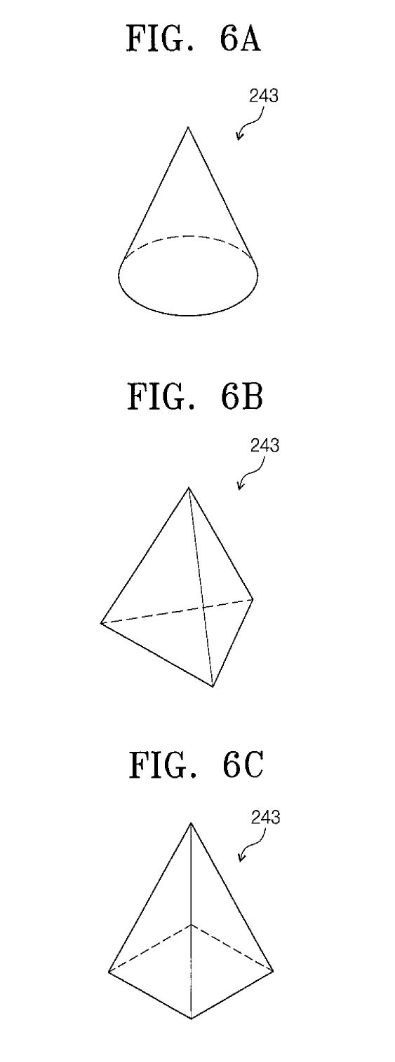

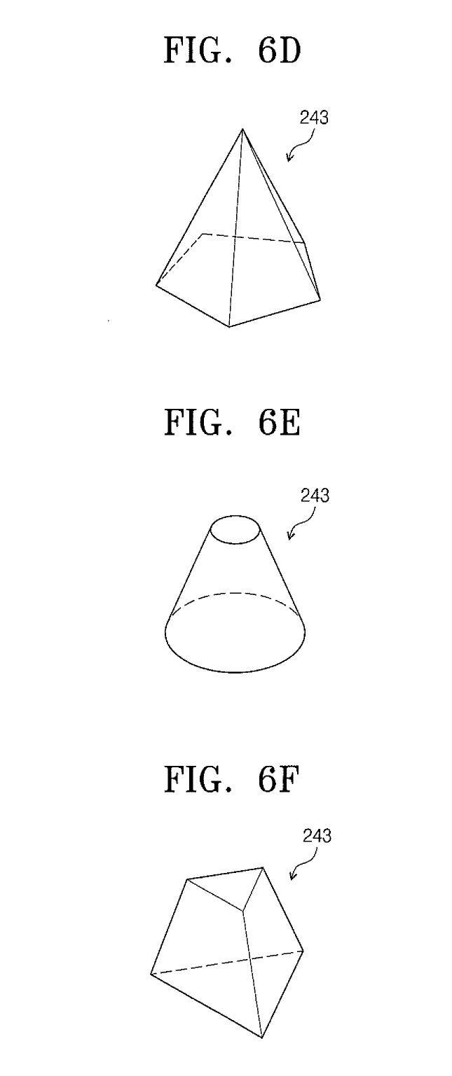

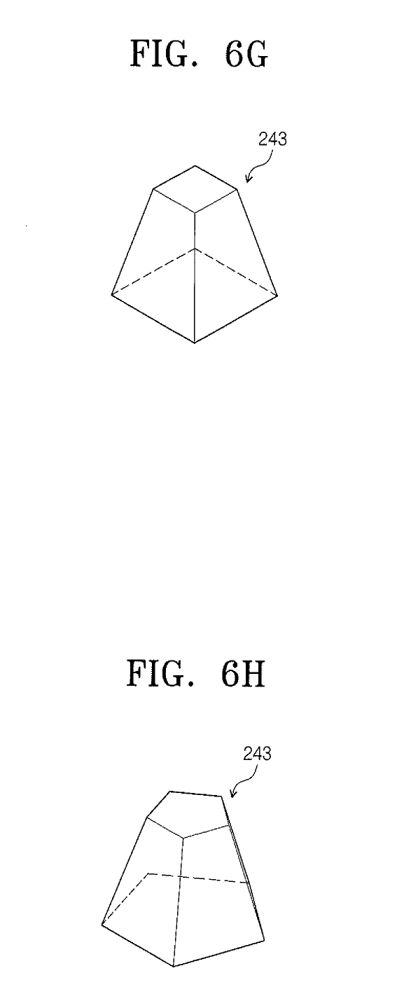

FIGS. 6A to 6H are views showing various shapes of exemplary embodiments of the reflector according to the invention.

Referring to FIGS. 6A to 6H, the reflector 243 may have various shapes, e.g., a cone shape (FIG. 6A), a truncated cone shape (FIG. 6E), an n pyramid shape (FIGS. 6B, 6C and 6D), an m truncated pyramid shape (FIGS. 6F, 6G and 6H), etc. Here, each of “n” and “m” is a natural number equal to or greater than 3. When the reflector 243 is provided in a plural number, the reflectors 243 have the same or different shapes.

Referring to FIG. 5A again, the reflector 243 is disposed on the reflection sheet 210 and included in the active layer 220 including the scattering particles 221. The reflector 243 is disposed under the light source 231 and overlapped with a portion of the light source 231.

Referring to FIG. 5B again, the reflector 243 is disposed on the reflection sheet 210 and included in the active layer 220 including the scattering particles 221 and the light emission particles 223. The reflector 243 is disposed under the light source 231 and overlapped with a portion of the light source 231.

Referring to FIG. 5C again, the reflector 243 is disposed on the reflection sheet 210 and disposed under the light source unit 230 including the light emission cover layer 224. The reflector 243 is included in the active layer 220. The reflector 243 is disposed under the light source 231 and overlapped with a portion of the light source 231.

Referring to FIG. 5D again, the reflector 243 is disposed on the reflection sheet 210 and under the light emission particle layer 225. The reflector 243 is included in the active layer 220. The reflector 243 is disposed under the light source 231 and overlapped with a portion of the light source 231.

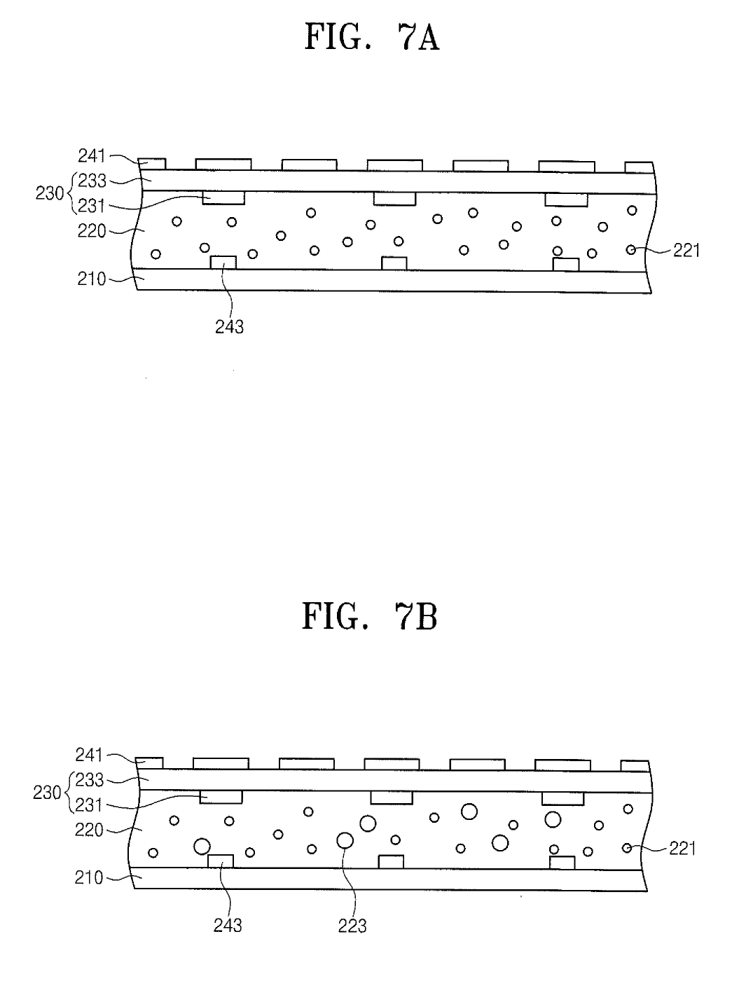

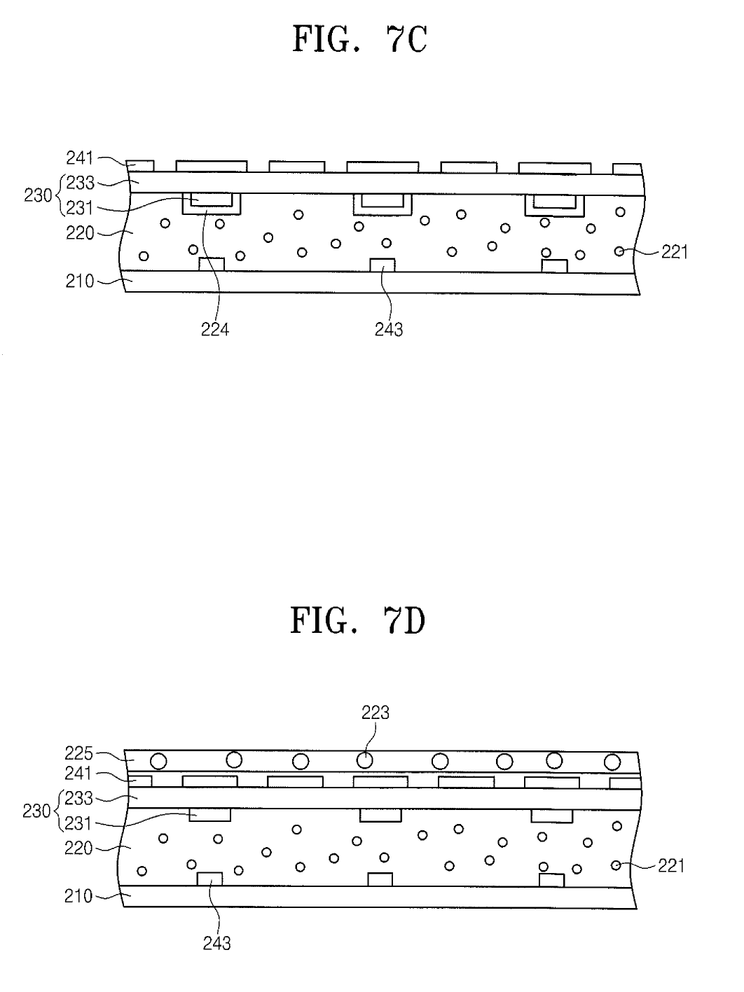

FIGS. 7A to 7D are cross-sectional views showing yet other exemplary embodiments of a backlight unit of a display device according to the invention.

Referring to FIGS. 7A to 7D, the backlight unit 200 includes the reflection pattern 241 and the reflector 243.

Referring to FIG. 7A, the reflection pattern 241 is disposed on the active layer 220 including the scattering particles 221. A portion of the reflection pattern 241 disposed on the active layer 220 including the scattering particles 221 covers the light source 231. The reflector 243 is disposed on the reflection sheet 210 and included in the active layer 220 including the scattering particles 221. The reflector 243 is disposed under the light source 231 to overlap with a portion of the light source 231 when viewed in the (top) plan view.

Referring to FIG. 7B, the reflection pattern 241 is disposed on the active layer 220 including the scattering particles 221 and the light emission particles 223. A portion of the reflection pattern 241 disposed on the active layer 220, which includes the scattering particles 221 and the light emission particles 223, covers the light source 231. The reflector 243 is disposed on the reflection sheet 210 and included in the active layer 220 including the scattering particles 221 and the light emission particles 223. The reflector 243 is disposed under the light source 231 to overlap with a portion of the light source 231 when viewed in the (top) plan view.

Referring to FIG. 7C, the reflection pattern 241 is disposed on the light source unit 230 including the light emission cover layer 224. A portion of the reflection pattern 241 disposed on the light source unit 230 including the light emission cover layer 224 covers the light source 231. The reflector 243 is disposed on the reflection sheet 210 and disposed under the light source unit 230 including the light emission cover layer 224. The reflector 243 is disposed under the light source 231 to overlap with a portion of the light source 231 when viewed in the (top) plan view.

Referring to FIG. 7D, the reflection pattern 241 is disposed on the light emission particle layer 225. A portion of the reflection pattern 241 disposed on the light emission particle layer 225 covers the light source 231. The reflector 243 is disposed on the reflection sheet 210 and disposed under the light emission particle layer 225. The reflector 243 is included in the active layer 220. The reflector 243 is disposed under the light source 231 to overlap with a portion of the light source 231 when viewed in the (top) plan view.

A conventional display device includes the light source disposed to emit the first light to the direction DR1 from the rear surface 120 to the display surface 110, so that the viewing angle of the light is relatively narrow. In one or more exemplary embodiment of the display device 10 according to the invention, the light source 231 is disposed to emit the first light to the direction DR2 which is taken from the display surface 110 to the rear surface 120, that is, away from or opposite to a viewing side of the display device 10. In addition, the first light is reflected to various directions by the reflection sheet 210, the reflection pattern 241 and the reflector 243. Accordingly, the viewing angle of the light may be broadened and the visibility may be improved.

Hereinafter, a manufacturing method of a display device will be described in detail.

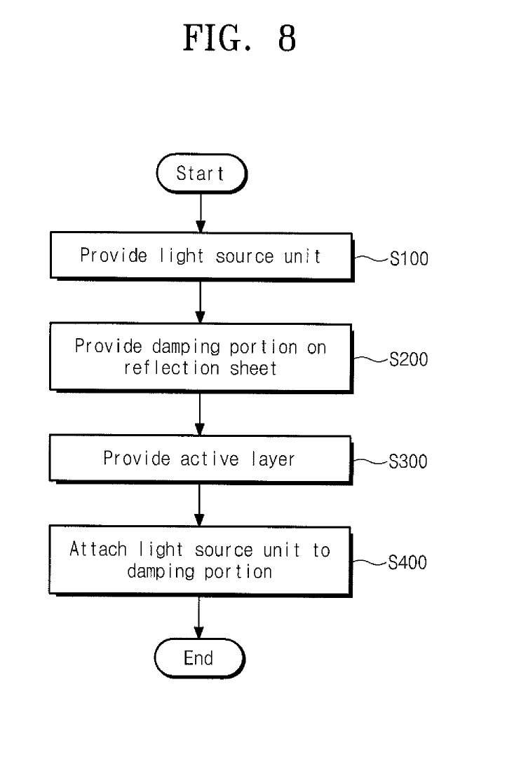

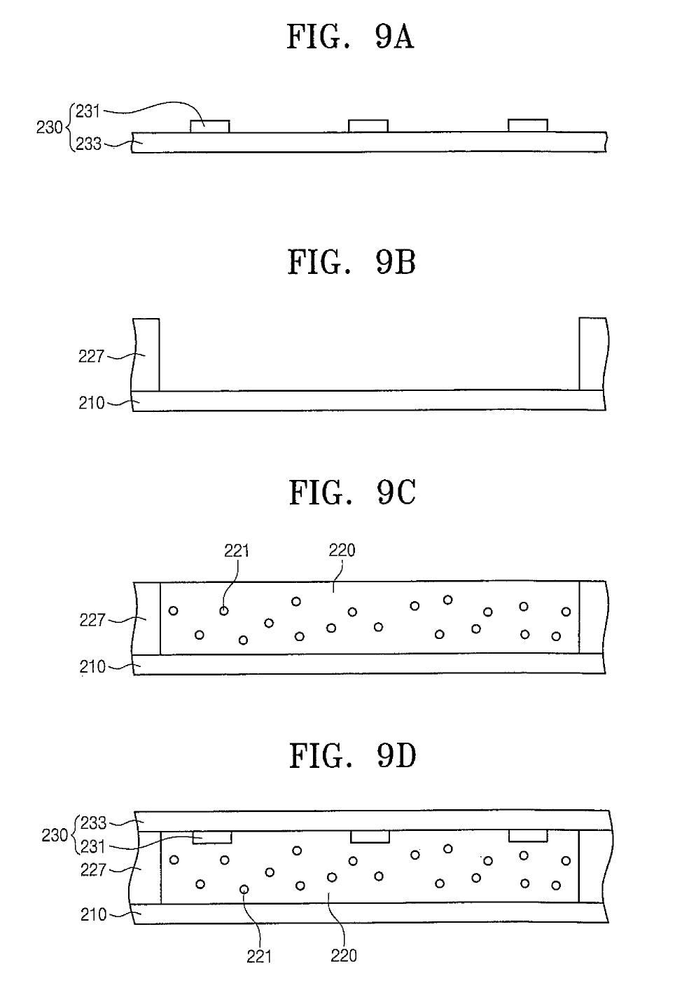

FIG. 8 is a flowchart showing an exemplary embodiment of a manufacturing method of a display device according to the invention and FIGS. 9A to 9D are views showing the manufacturing method of the display device according to the invention.

Referring to FIGS. 8 and 9A, the light source 231 is mounted on the surface of the circuit board 233 to form (e.g., provide) the light source unit 230 (S100). The light source 231 may be provided in a plural number and the circuit board 233 may be the transparent or semi-transparent.

Referring to FIGS. 8 and 9B, a damping portion including a damper 227 is formed on the reflection sheet 210 to define a space on the reflection sheet 210 at which the active layer 220 will be formed (S200). In an exemplary embodiment, the active layer 220 may be formed without the damper 227. The active layer 220 formed without the damper may be laminated onto the reflection 210.

The damper 227 is formed at an edge of the reflection sheet 210.

The damper 227 may include an optical clear adhesive (“OCA”) or an optical clear resin (“OCR”), but is not limited thereto or thereby.

Referring to FIGS. 8 and 9C, the active layer 220 in which the scattering particles 221 are distributed is formed in the space defined on the reflection sheet 210 (S300). The active layer 220 includes the scattering particles 221 and a resin. The resin may be the silicon-based resin.

The scattering particles 221 are configured to scatter a portion or an entire of the first light. The scattering particles 221 includes at least one metal selected from gold, silver, aluminum, platinum, palladium, cadmium, cobalt, ruthenium, copper, indium, nickel and iron, an alloy thereof, titanium dioxide (TiO₂) and silicon dioxide (SiO₂).

Referring to FIGS. 3B, 4B, 5B and 7B, the active layer 220 may further include the light emission particles 223. The light emission particles 223 are configured to receive the first light emitted from the light source 231 and generate the second light having the wavelength different from that of the first light. The light emission particles 223 may include the fluorescent substance or the quantum dot.

In addition, the scattering particles 221 may scatter a portion of the second light.

Referring to FIGS. 3C, 4C, 5C and 7C, the manufacturing method of the display device may further include forming the light emission cover layer 224 to cover the light source 231 disposed on the circuit board 223. The light emission cover layer 224 is configured to receive the first light emitted from the light source 231 and generate the second light having the wavelength different from the first light. The light emission cover layer 224 may include the fluorescent substance and/or the quantum dot.

Referring to FIGS. 3D, 4D, 5D and 7D, the manufacturing method of the display device may further include forming the light emission particle layer 225 between the display panel 100 and the circuit board 233. The light emission particle layer 225 is configured to receive the first light emitted from the light source 231 and generate the second light having the wavelength different from that of the first light. The light emission particle layer 225 may include the fluorescent substance and/or the quantum dot.

Referring to FIGS. 4A to 4D and 7A to 7D, the manufacturing method of the display device may further include forming the reflection pattern 241 on a surface of the circuit board 233 opposite to that upon which the light source 231 is disposed, such that a portion of the reflection pattern 241 covers the light source 231 when viewed in a plan view.

The portion of the reflection pattern 241 covers the light source 231. The reflection pattern 241 is provided in a plural number.

A portion of the reflection pattern 241 covers the light source 231 when viewed in the thickness direction, e.g., the direction DR1, of the display panel 100. When the reflection pattern 241 covers the light source 231, the viewer recognizing the reflection pattern 241 as a foreign object when the viewer sees the image displayed through the display device is reduced or effectively prevented.

Referring to FIGS. 5A to 5D and 7A to 7D, the manufacturing method of the display device may further include the reflector 243 on the reflection sheet 210. The reflector 243 is disposed to overlap a portion of the light source 231.

In an exemplary embodiment, for instance, the reflector 243 is overlapped with a portion of the light source 231 when viewed in the thickness direction, e.g., the direction DR1, of the display panel 100.

The reflector 243 is provided in a plural number.

The reflector 243 is disposed under the light source 231 and partially overlaps the light source 231 to reflect the first light emitted from the light source 231 to various directions. Accordingly, the viewing angle of the light of the display device may be improved and the visibility of the viewer may be improved.

In addition, the reflector 243 reflects the second light to various directions.

Referring to FIGS. 8 and 9D, the manufacturing method of the display device includes attaching the light source unit 230 to the damper 227 (S400). The light source unit 230 is coupled to the reflection sheet 210 by the damper 227, and thus the display device 10 is manufactured.

In a conventional display device, the light source is disposed to emit the first light to a direction to which the backlight unit and the display panel are stacked, so that the viewing angle of the light is relatively narrow. However, according to one or more exemplary embodiment of the manufacturing method of the display device according to the invention, the light source unit is disposed to emit the first light to a direction opposite to the direction to which the backlight unit and the display panel are stacked, e.g., away from the display panel, and the first light is reflected to various directions by the reflection sheet, the reflection pattern and the reflector, which are disposed under the light source unit. Thus, the viewing angle of the light of the display device may be improved and the visibility of the viewer may be improved.

Although the exemplary embodiments of the invention have been described, it is understood that the invention is not limited to these exemplary embodiments but various changes and modifications can be made by one ordinary skilled in the art within the spirit and scope of the invention as hereinafter claimed.

What is claimed is:

1. A display device comprising:
a display panel comprising a display surface on which an image is displayed and a rear surface opposite to the display surface; and
a backlight unit which is under the display panel and supplies a light to the display panel, the backlight unit comprising:
a light source unit which emits a first light in a direction taken from the display surface to the rear surface;
a reflection sheet which reflects the first light; and
an active layer between the light source unit and the reflection sheet, and comprising a scattering particle which scatters the first light.

2. The display device of claim 1, wherein the active layer further comprises a light emission particle which receives the first light and generate a second light having a wavelength different from a wavelength of the first light.

3. The display device of claim 2, wherein the light emission particle comprises a fluorescent substance or a quantum dot.

4. The display device of claim 1, wherein the light source unit comprises:
a light source; and
a circuit board which applies a power source voltage to the light source mounted on a surface of the circuit board,
wherein the light source protrudes toward the reflection sheet.

5. The display device of claim 4, wherein the circuit board is transparent or semi-transparent.

6. The display device of claim 4, wherein
the light source unit further comprises a light emission cover layer which covers the light source on the circuit board, and
the light emission cover layer comprises a fluorescent substance or a quantum dot.

7. The display device of claim 4, wherein
the backlight unit further comprises a light emission particle layer between the display panel and the circuit board, and
the light emission particle layer comprises a fluorescent substance or a quantum dot.

8. The display device of claim 4, wherein
the backlight unit further comprises a reflection pattern between the display panel and the light source unit, and
the reflection pattern overlaps the light source in a plan view.

9. The display device of claim 1, wherein
the backlight unit further comprises an optical member between the display panel and the light source unit, and
the optical member comprises a concavo-convex shape at a surface thereof.

10. The display device of claim 1, wherein the reflection sheet, the active layer, the light source unit and the display panel are sequentially stacked one on another.

11. The display device of claim 4, wherein the backlight unit further comprises a reflector which is between the reflection sheet and the light source unit and reflects the first light.

12. The display device of claim 11, wherein the reflector overlaps the light source.

13. The display device of claim 11, wherein in a cross-section, the reflector has a cone shape, a truncated cone shape, an n pyramid shape or an m truncated pyramid shape, and each of “n” and “m” is a natural number equal to or greater than 3.

14. The display device of claim 1, wherein the scattering particle comprises at least one metal selected from gold, silver, aluminum, platinum, palladium, cadmium, cobalt, ruthenium, copper, indium, nickel and iron, an alloy thereof, titanium dioxide (TiO₂) and silicon dioxide (SiO₂).

15. A method of manufacturing a display device, comprising:
mounting a light source on a surface of a circuit board, to form a light source unit;
forming a damper on a reflection sheet, to define a space on the reflection sheet;
forming an active layer comprising a scattering particle, in the space on the reflection sheet; and
attaching the light source unit to the damper, to seal the active layer.

16. The method of claim 15, wherein the active layer further comprises a light emission particle.

17. The method of claim 15, further comprising forming a light emission cover layer which covers the light source on the circuit board.

18. The method of claim 15, further comprising forming a light emission particle layer between the display panel and the circuit board.

19. The method of claim 15, further comprising forming a reflection pattern on a surface of the circuit board opposite to the surface on which the light source is mounted,
wherein the reflection pattern overlaps the light source in a plan view.

20. The method of claim 15, further comprising forming a reflector on the reflection sheet,
wherein the reflector overlaps the light source in a plan view.
